(19) United States
(12) Patent Application Publication
(10) Pub. No.: US 2005/0188022 A1
(43) Pub. Date: Aug. 25, 2005

(54) Method and apparatus to provide a human-usable interface to conversational support

(76) Inventors: James Edwin Hanson, Yorktown Heights, NY (US); Fenno F. Heath III, Woodbridge, CT (US); Santosh Kumaran, Croton on Hudson, NY (US); Yashodhara Patnaik, Mount Kiso, NY (US); Prabir Nandi, Bayside, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/750,218

(22) Filed: Jan. 2, 2004

(51) Int. Cl. G06F 15/16

(52) U.S. Cl. 709/206

(57) ABSTRACT

A conversation support framework supports long running human interactions with conversation-enabled applications installed at remote locations. The conversation support may be provided for a user's personal computer (PC) or personal digital assistant (PDA), either as a “thick” or “thin” client implementation. The framework includes conversation support communicating with a browser installed on the user PC or PDA to support the user's side of a conversation with the conversation-enabled applications. Presentation support communicates with the browser to show the user a state of the conversation and options for selection by the user. The user selects an available option and fills in message content that conforms with the conversation policy in use by the conversation-enabled applications.

### CROSS-REFERENCE TO RELATED APPLICATION

This application is related in subject matter to co-pending application Ser. No. 10/128,864 filed Apr. 24, 2002, by Hanson et al. for “Apparatus and Method for Providing Modular Conversation Policies and Agents” (IBM Docket YOR920020017US1) and assigned to a common assignee herewith. The disclosure of application Ser. No. 10/128,864 is incorporated herein by reference.

### DESCRIPTION

### BACKGROUND OF THE INVENTION

1. Field of the Invention

The present invention generally relates to conversational mode data processing systems and, more particularly, to a specification to extend Application Program Interfaces (APIs) to enable human users to interact with conversation-enabled applications.

2. Background Description

Conversation support proposes and implements a conversational model of interaction between autonomous, intelligent entities. This is achieved by exchanging a sequence of correlated messages. At the heart of the conversation support technology is the notion of a conversation policy, that specifies the choreography of message exchange by constraining the sequence in which messages are sent and received, the format of individual messages and any timing restrictions. Each entity in the conversation is enabled with a conversation support module that executes one or more of these conversation policies. In addition the conversation support module mediates between the messaging infrastructure and the decisions made by the entities at various points in the conversation.

Our work hitherto has focussed on providing conversation support to solve e-business integration problems for Business-to-Business (B2B) and Enterprise Application Integration (EAI). In B2B, conversation support facilities e-business interactions between BPM modules of trading partners. In case of EAI, conversation adapters provide a means to model complex interactions with an enterprise information system like SAP, Siebel, Ariba etc. This invention takes the next step in Human Computer Interaction (HCl), by enabling a human-useable interface to conversation support.

One such human-usable interface is a Web browser. Web browsers are ubiquitous on personal computers. Traditionally, a web browser is used as a “dumb” client to display content served up by a Web server. Web browsers may also be used to channel user requests to the server for further processing. Providing conversation support technology as a browser plugin enables the user to download conversation policies of his or her choice and interact with peer systems that support a compatible policy. For example, a user can download his or her favorite travel booking policy TAQuick101 from an independent policy provider and use that to create his or her travel reservations with Amex Travels who also support the same policy (amongst numerous other travel policies).

The architecture of a system in which conversation support is provided in a browser plugin was described in the paper entitled “Conversational Browser” available on Conversation Support Website (http://www.research.ibm.com/convsupport).

While Web browsers on personal computers are an especially good example of a human-usable interface, many communication devices now in use or envisioned do not support a Web browser. Empowering the user of communication devices, such as wireless personal digital assistants (PDAs), cell phones with PDA functionality, and the like, will change the entire Business-to-Consumer (B2C) business landscape. With the availability of more and more innovative conversation policies, the user has more choices and better influence on the quality of service of the provider.

### SUMMARY OF THE INVENTION

It is therefore an object of the present invention to provide a human-usable interface to conversation support which supports multiple different communication devices.

It is a further object of this invention to provide a human-usable interface to conversation support which does not require the installation of specialized software on the client communication device.

According to the invention, a conversation support framework supports long running human interactions. The salient features of the implementation are the following:
a small footprint,
automatic generation of views to show messages received in the conversation and screen forms to solicit decision input from the user,
plug and play support for various on-wire message formats, viz., XML, WSDL, serialized Java, etc., and
plug and play support for various incoming and outgoing messaging protocols, viz., e-mail, http, web services etc.
   The invention also includes the contracts required to be fulfilled by an independent policy provider. We have also defined an archive format for bundling of conversation policies and message schemas. It is called a Policy Archive format or PAR. Policy archive files will have the file extension of “par”. In addition, a presentation archive format has been defined to contain the presentation formats for PAR files. It is called a Policy Presentation Archive or PPAR. Conceptually, they are “skins” that adorn conversation policies for presentation on the browser. Policy Presentation Archive files will have the file extension of “ppar”.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the relation of the invention to the conversation management architecture and system;

FIG. 2 is a block diagram showing a preferred embodiment of the invention, wherein a browser running on a client device is connected to a web server which provides conversation support for the client;

FIG. 3 is a block diagram showing a conversation-enabled server capable of connecting to a variety of different user devices;

FIG. 4 is a block diagram illustrating the presentation support according to the invention;

FIG. 5 is a block diagram illustrating by way of example a customer interaction with a restaurant service;

FIG. 6 is a block diagram showing a conversation-enabled server configured as a third-party provider of conversation-support services to subscribing users;

FIG. 7 is a data flow diagram of the process of installing the restaurant service;

FIG. 8 is a data flow diagram of the process of loading the restaurant service;

FIG. 9 is a data flow diagram of the process of choosing conversation parameters of the restaurant service;

FIG. 10 is a data flow diagram of the process of initiating the conversation in the restaurant service;

FIG. 11 is a data flow diagram of the process of sending a message which involves rendering the data input form;

FIG. 12 is a data flow diagram of the process of sending a message which involves sending the entered data;

FIG. 13 is a data flow diagram of the process of receiving a message which involves rendering the received message;

FIG. 14 is a data flow diagram of the process of receiving a message which involves responding to the received message; and

FIG. 15 is a program flow diagram of the interaction between a conversation-support services host and a subscriber.

### DETAILED DESCRIPTION OF A PREFERRED EMBODIMENT OF THE INVENTION

The word “conversation” essentially describes the act of two or more parties or entities interacting with each other to achieve a meaningful end. “Conversation support” elucidates an architecture, specification and infrastructure required to support multi-step, stateful interactions between components. Conversation support for electronic business (e-business) extends the notion of human conversation to the realm of electronic transactions. It is an architecture by which two or more computers belonging to different parties can “talk” with each other to conduct business over a network, such as the Internet. The architecture is grounded on two main concepts:
The conversation verbiage. The conversation verbiage includes the act of initiating/terminating a conversation and the act of sending/receiving a message in conversation.
The sequence or rules governing the conversation. This is specified using a Conversation Policy (CP) that provides a transcript describing the interaction. Conversing parties follow this common script to speak as and when required.
   Take, for example, a conversation between a buyer and a seller governed by a CP that deals with haggling on the price for the purchased commodity. The buyer may receive offers from the seller and make counter-offers to the seller. As a result, the buyer and seller would need to decide whether to agree or disagree with an offered price. If the buyer agrees to a seller's offer, a confirmation is sent to the seller, but if not, the seller may send a counter-offer to the seller or request the seller to send another offer. Thus, the conversation support mechanism side would need to pass “please decide” messages to the application logic and, in turn, accept “decisions” from the application logic.

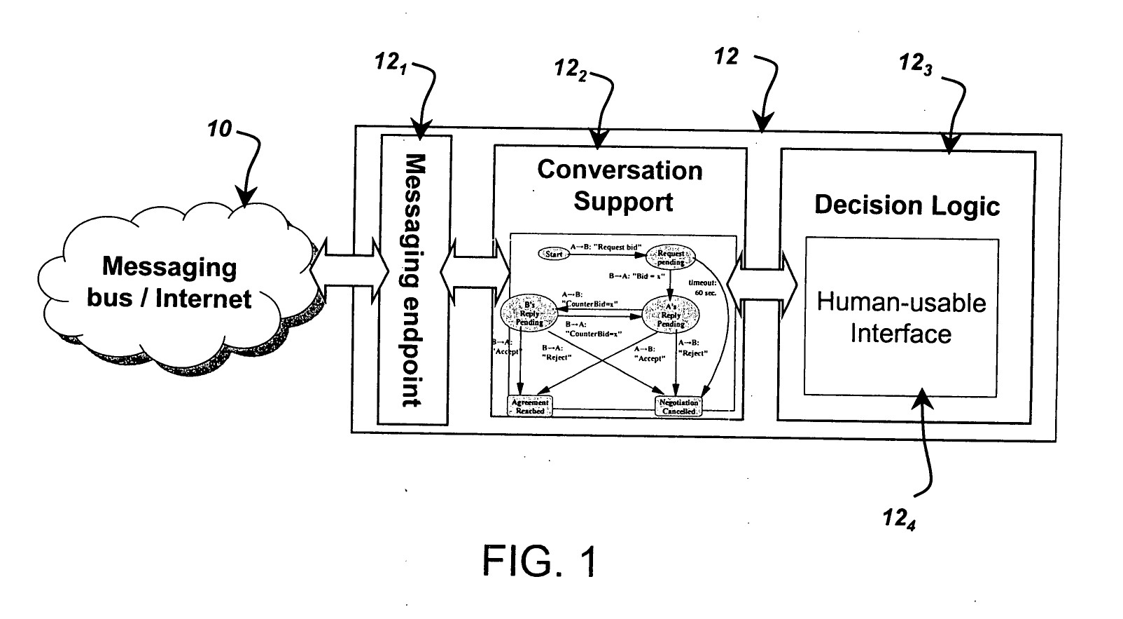

Referring now to the drawings, and more particularly to FIG. 1, there is shown a block diagram providing an overview of the invention. This represents one of the participants in the conversation; that is, it is assumed that there are two parties connected to a messaging bus 10, such as the Internet. Only one of these parties 12 is shown, but it will be understood that the other party also supports conversational interactions, so it will not be described. The party 12 comprises three components; a messaging endpoint 12, which provides the interface to the messaging bus 10, a conversation management support component 12₂, and a decision logic module 12₃. The conversation management component 12₂ functions as indicated by way of the example of the included state chart diagram. That is, the conversation is initiated by party A sending a “Request bid” message to party B. Party B receives the message, and a timer is started at party A. This timer is set for some arbitrary time, say 60 seconds, and if it times out, the negotiation is canceled. However, if before the timer times out party B sends a bid to party A, party A can do one of three things in reply. First, party A may send a “Reject” message to party B, ending the negotiation. Second, party A may send an “Accept” message to party B, concluding an agreement. Third, party A may send a “Counter bid” message to party B. If a “Counter bid” message is sent to party B, party may do one of three things in reply, similar to party A as just described. It ill be appreciated that the particular messages and sequencing rules described here are illustrative examples only. As shown in co-pending patent application Ser. No. 10/128,864 referenced above, the conversation support module can be configured for any set of messages and sequencing rules. In this process, the decision logic module 12₃ makes use of a human-usable interface 12₄ according to the invention, enabling a person to act as the decision-making part of the “application logic” in the conversation.

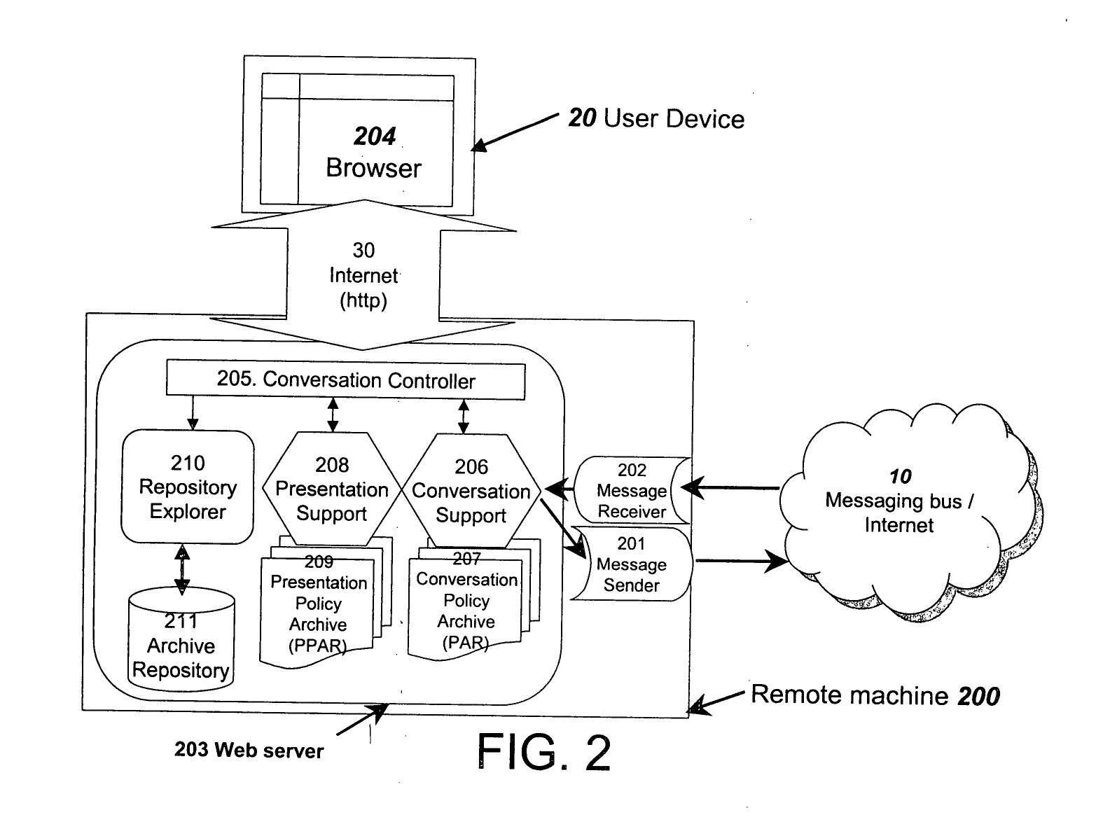

FIG. 2 shows in more detail the architecture of an embodiment of the invention in which a server, equipped with conversation support, is connected with a client device that has a human-usable interface. In this case, the human-usable interface is the browser 204, running on a user device 10. The user device 20 communicates with a Web server machine 200 which is attached to, for example, the Internet 10. The server machine 200 includes a message sender 201 and a message receiver 202 which together form the messaging endpoint 121 of FIG. 1 and provide the interface to the Internet 10. The message sender 201 and the message receiver 202 abstract the transport mechanisms for sending and receiving messages. The message sender 201 and the message receiver 202 are part of the conversation server 303 which interfaces with the browser 204 by means of a conversation controller 205. The connection between the conversation controller 205 in the conversation server 303 and the browser 204 in the user machine 200 is now made by way of the Internet 30 using a protocol such as hypertext transfer protocol (http). The browser 204 may be a standard Web browser, such as Internet Explorer. The conversation controller 205 is an application component, such as a servlet, that implements the communication interface between the browser and server. The server includes a conversation support module 206 which is an implementation of the conversation support interfaces. The conversation support module 206 is configured with one or more conversation policies (CPs), which may have been obtained, for example, from a third party in the form of policy archive (PAR) files. Details of the operation of the conversation support module 206 may be had by reference to co-pending patent application Ser. No. 10/128,864. The conversation support module 206 accesses a policy archive (PAR) 207 and generates messages, under the control of the conversation controller 205, which are sent by the message sender 201 and passes received messages from the message receiver 202 to the conversation controller 205. The PAR 207 is a formatted file that contains the policy files and the related message schemas. In parallel with the conversation support module 206, a presentation support module 208 accesses a policy presentation archive (PPAR) 209 and, through the conversation controller 206, generates the graphic user interface (GUI) supported by the browser 204. The presentation support module 208 is responsible for handling the presentation needs of the conversational browser 204. The PPAR 209 is a formatted file containing the presentation mappers from message schemas to the display screen (not shown) of the user machine 200. A repository explorer 210, controlled by the conversation controller 206, maintains an archive repository database 211 of the “conversation” between the user machine 200 and another party's machine (not shown). The repository explorer 210 is a user interface (UI) screen flow to manage the archive repository 211. The purpose of the archive repository database 211 is to maintain the downloaded policy archives and presentation archives.

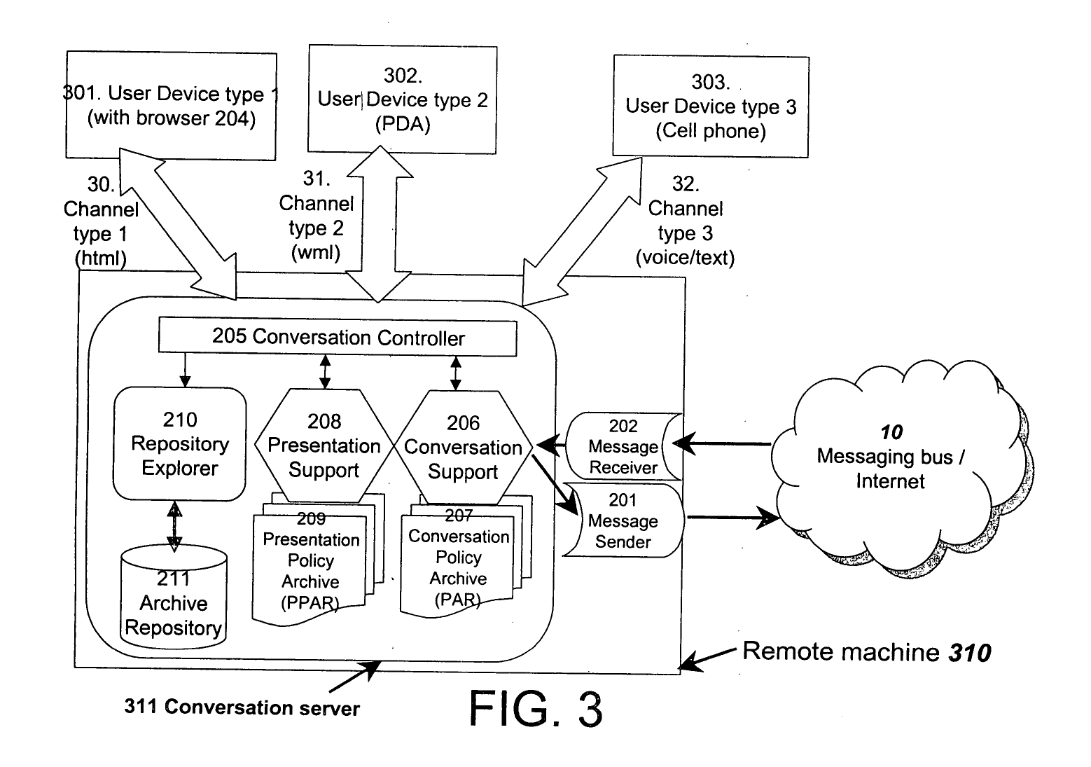

The same functions can be supported in servers equipped to connect with user devices other than browsers, as shown in FIG. 3. Without limiting the generality of the invention, only three types of user device are shown in the figure. Each of the user devices 301, 302 and 303 shown interacts with the conversation server 311 on a remote machine 310, using a communication channel appropriate to that device type. In this example, user device 301, which is the same device as the user machine 20 and browser 204 in FIG. 2, communicates with the server using the Internet 30, as in FIG. 2. User device 302 uses the Internet to send and receive WML (Wireless Markup Language) messages. User device 303 uses a voice and text connection to send and receive information. The information exchanged between the server and each type of user device is specific to that device type. The server accommodates a multiplicity of device types by means of presentation policy archives (PPAR) 209, stored in the archive repository 211. For combination of conversation policy and device type, a different presentation policy archive is used to generate markup appropriate to that device type and conversation policy.

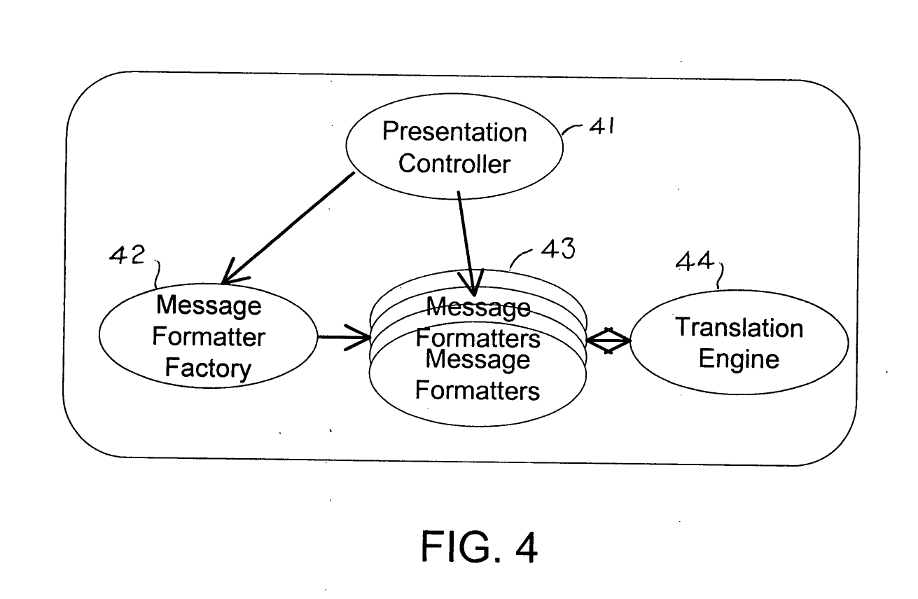

The presentation support module 208 is shown in more detail in FIG. 4. The presentation support module is responsible for presenting the messages to the user, processing the user messages and formatting the messages through message formatters. More particularly, the presentation support module includes a presentation controller 41 which controls a message formatter factory 42 and message formatters 43. A translation engine 44 is used to generate the messages which are presented on the user device. The formatted messages are sent to the participating parties through the conversation support module 206.

The message formatters 43 are responsible for translating incoming messages from message schemas to presentable markup, and translating outgoing message data to an outgoing message. The message formatter factory 42 is responsible for instantiating a particular type of message formatter. The message formatter 43 uses message mappers from the presentation archive (PPAR) 209 to translate messages and schemas using the translation engine 44. There are four types of mappers:

Incoming Message Mapper: In the preferred embodiment, conversing parties in a conversation exchange XML (extensible Markup Language) messages. A human participant may receive conversation messages through message receivers (i.e., 202 in FIG. 2). These messages are, typically, in XML format. The conversational browser renders these messages to the user through mapping to markup screens. A presentation archive (PPAR) contains one mapping per incoming message schema. These XML style sheet files translate incoming messages to markup screens.

It should be noted that XML is but one example of an on-wire message format and other formats could be used in alternative implementations of the invention. The architecture allows for plugging in the appropriate message formatter based on the on-wire message format. Thus, while the preferred embodiment of the invention uses XML, other on-wire formats, and corresponding formatters, may be used in the practice of the invention.

Schema Markup Mapper: As part of a conversation, a user sends messages to other conversing parties. When a user is required to send a message, the browser renders a form to collect message data. This markup mapper is a screen that renders this form. These screens are defined per outgoing message schema in the presentation archive (PPAR) file. They implicitly assume the structure of the outgoing message.

Schema Translation Mapper: Like the schema markup mapper, these mapping files map outgoing message schemas to markups that render a form to collect the outgoing message data. These XSL (eXtensible Style Language) style sheet mappings are more dynamic and can absorb easily any changes in the schema. Unlike schema markup mappers, these mapping files do not “hard code” screens; rather, the screens are generated by translating the message schema with this schema translator XSL style sheet. A policy presentation archive may provide one of the schema markup mapper or schema translation mapper per outgoing message schema.

Outgoing Message Mapper: Outgoing message data is collected from the user as name-value pairs. These mapping XSL style sheets translate these name-value pairs to outgoing XML messages.

The following are the major functionalities of the presentation Support module:
Format the incoming messages and provide presentable markup to the user device: An incoming message received through the message receiver 202 may not be in a form desirable for presentation to the user. The presentation support module translates these messages to markup appropriate for the user device using the “incoming message mappers” from the presentation archive (PAR) 207. The translated markup is sent to the user device for rendering 204.
The conversation controller 205 queries the conversation support module 206 for any possible actions in the current conversation state. For example, it is frequently the case that, after a certain message has been received, the conversation policy in use specifies a set of specific responses—i.e., potential actions—that are available to the user. These actions are passed to the presentation support module 208, mapped to markup and presented to the user. Each action may require a message to be sent, this information is retrieved from the conversation support, and mapped to the markup through the schema markup mappers and/or schema translation mappers from the presentation archive (PPAR) 209. The transformed markup is sent to the conversation controller 205 for transmission to the user device.
Format the user submitted data to the message schemas: The user submits the message data through forms. This data needs to be formatted before handing over to the conversation support. Message data is collected as name-value pairs from the user. The presentation support module 208 uses the outgoing message mappers from presentation archives (PPAR) 209 to format messages to conform to the message schemas.

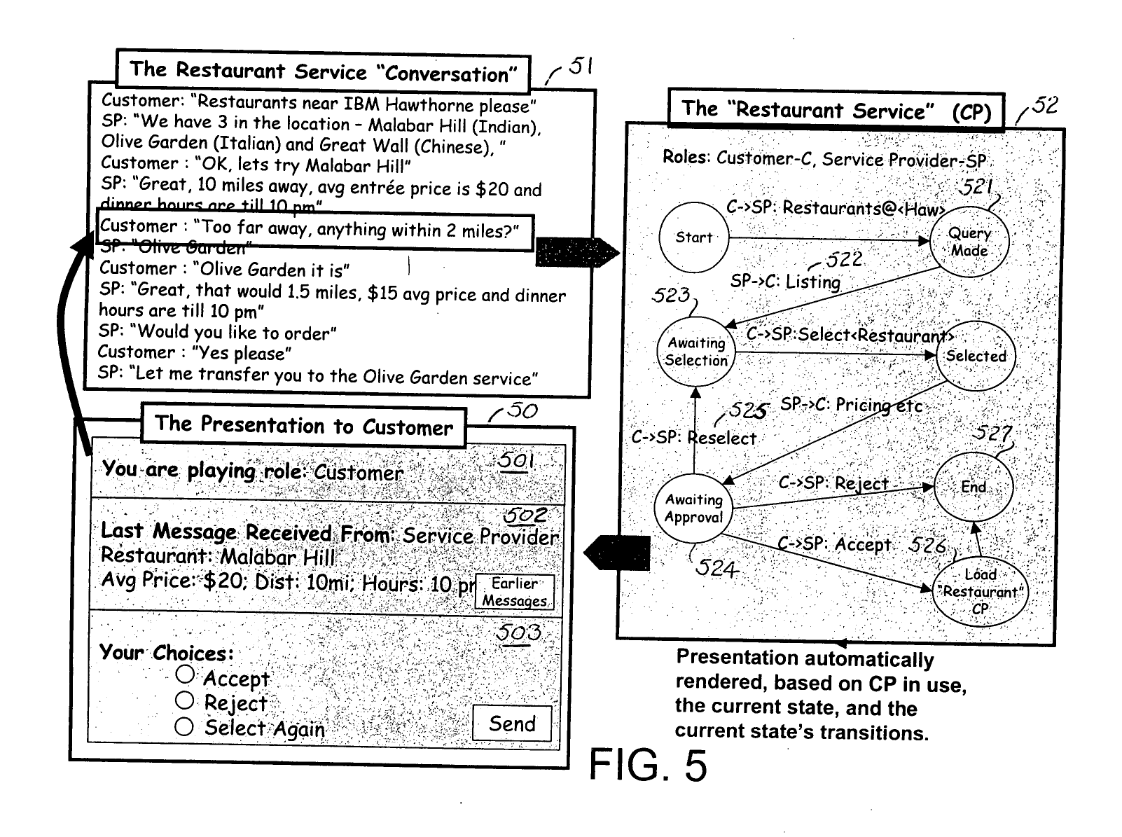

FIG. 5 provides an illustration of one example in the way in which the invention may be used. This example is a restaurant service application hosted by a telephone company (also known as the service provider). In this example, the service provider provides the customer with a list of restaurants that have signed up with the service provider. The customer (user) is looking for a restaurant near his or her present location. The restaurant service application guides the customer to select one of the restaurants. When the customer makes a selection, the restaurant service application passes control to the selected restaurant's order service to enable the customer to make a reservation or place an order for take out.

The presentation to the customer (user) is shown at 50. This presentation is divided into three areas (or windows) 501, 502 and 503. Area 501 shows the role of the user. Area 502 shows the last message received from the service provider. Area 503 prompts the user to make a selection and send the selection as his or her message. Block 51 shows an example of the literal “conversation” between the customer and the service provider (SP). In this conversation, the customer is provided with three choices, but upon making a choice is told that the selection is ten miles away. The customer considers this too far and asks for something closer. There is only one choice within the milage constraint, and that choice is selected. At this point in the conversation, the service provider transfers the user to the selected restaurant’ order service to make reservations or order carry out.

The literal conversation in block 51 is mapped to the conversation policy (CP) generally indicated by the state diagram in block 52, and the conversation is presented to the customer as illustrated in block 50. More specifically, the process begins at 521 by the user (customer) contacting the service provider requesting restaurants near his or her location. In response to this query, the service provider generates a listing 522 which is communicated to the user's machine and displayed in area 502. After the service provider provides a listing of restaurants near the user's current location, the user has to select one from the list. The selection is passed to the service provider, and the service provider responds by providing more details about the selected restaurant, such as cuisine type, hours, price ranges, etc. The service provider then waits at 523 for a response from the user. Now, the user may do one of three things at 524; the user may (1) accept a selection, (2) request a re-selection or (3) reject the selections offered. This continues in a loop, until the user chooses to accept a particular choice. If, as in the scenario of the conversation illustrated in block 51, the user requests a re-selection, a new listing is provided by the service provider at 525, which allows the user the same three options as before. If, again as in the scenario of the conversation illustrated in block 51, the user finally accepts a selection, a transfer is made to the selected restaurant at 526. The user could, of course, reject the selections provided, in which case the process ends at 527. In each of the states, the presentation 50 is automatically rendered, based on the conversation policy (CP) in use, the current state, and the current state's transitions, as shown by the example of block 52.

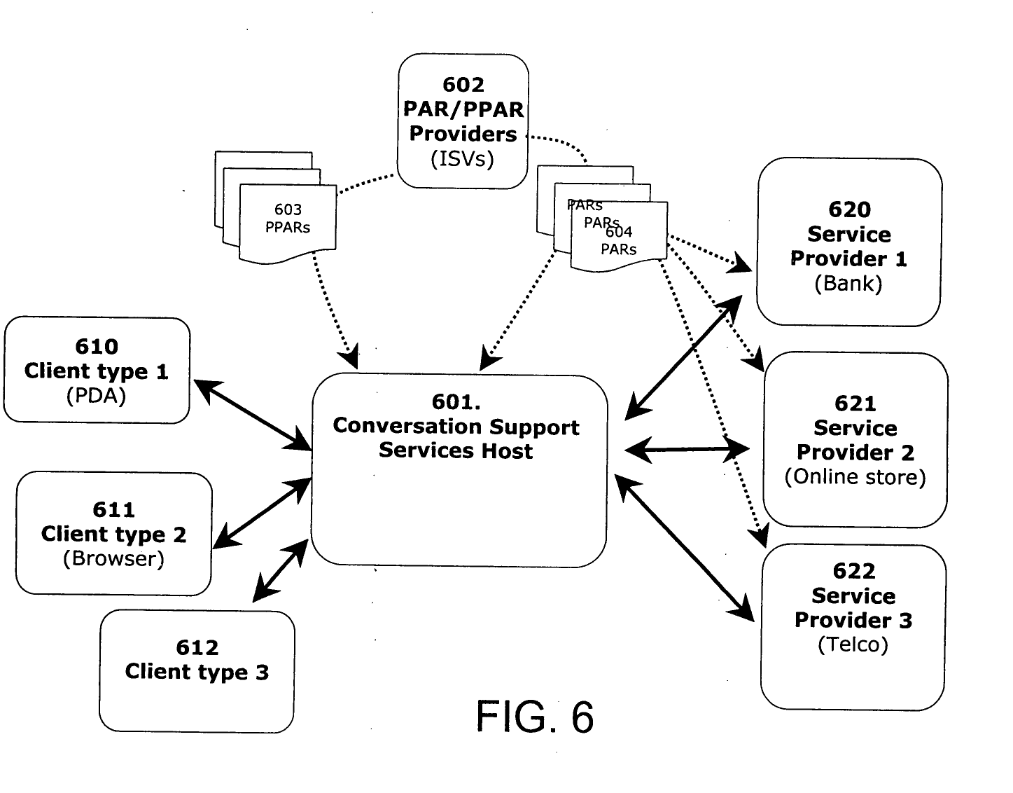

FIG. 6 shows a conversation server 601 which is a third-party provider of conversation-support services for users which subscribe to it. The users interact with the conversation server 601 through a variety of client user devices 610, 611 and 612. The conversation server 601 obtains conversation policies and presentation policies in the form of PAR files 604 and PPAR files 603 from a third-party policy supplier 602. The policy supplier also provides PAR files to the service providers 620, 621, and 622 with which the conversation server 601 carries on conversations.

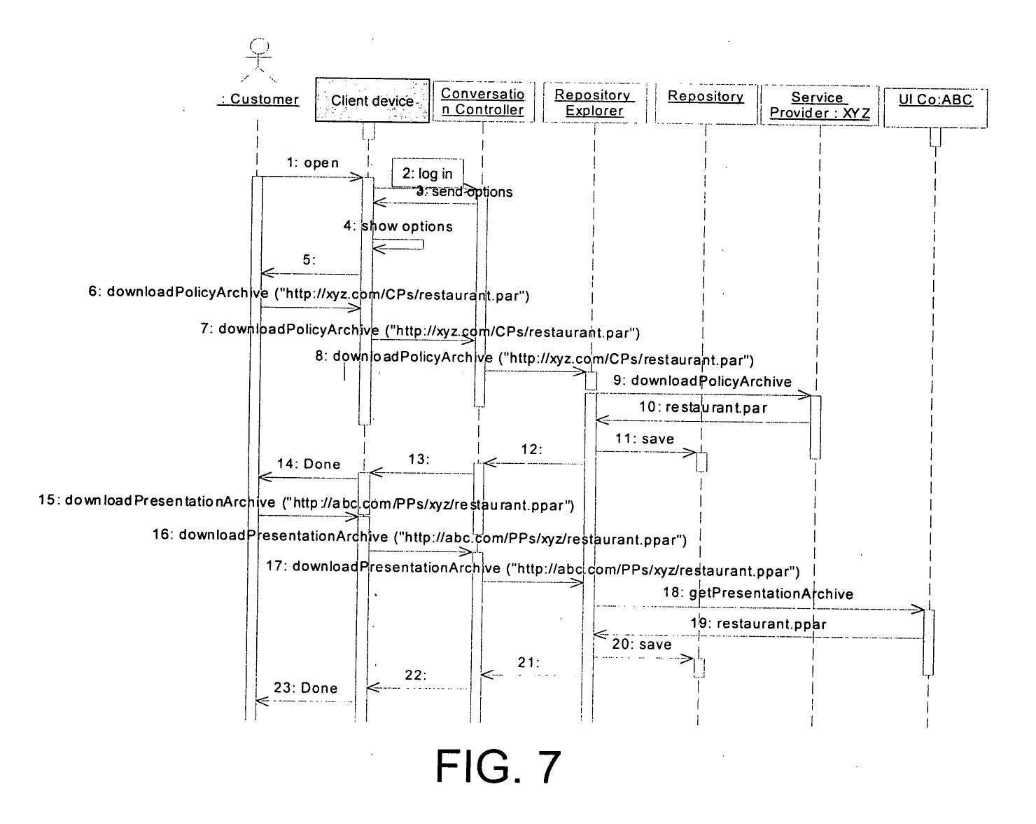

The following data flow diagrams illustrate how the policies are installed on the conversation support server, how a customer initiates the restaurant service conversation with the service provider, how the customer fills up and sends a message in conversation, and how a message received from the service provider is handled. Referring first to FIG. 7, the process by which the customer installs a new conversation policy and presentation policy (the restaurant service) is shown. In steps 1 to 5, the customer uses the user device to log onto the server, which, in turn, sends back to the user device a list of options that the user might take. At logon time, the server detects the user device type. The user device type will be used later to select the presentation policy archive (PPAR) appropriate to that device type. In steps 6 to 14, the customer selects the option of downloading a policy archive 207, supplying the URL (uniform resource locator) of a service provider from which to obtain it. The downloaded policy archive 207 (restaurant.par) is then stored on the server in the archive repository. In steps 15 to 23, the customer asks the server to download the corresponding presentation archive 209. The downloaded presentation archive (restaurant.ppar) is stored in the archive repository.

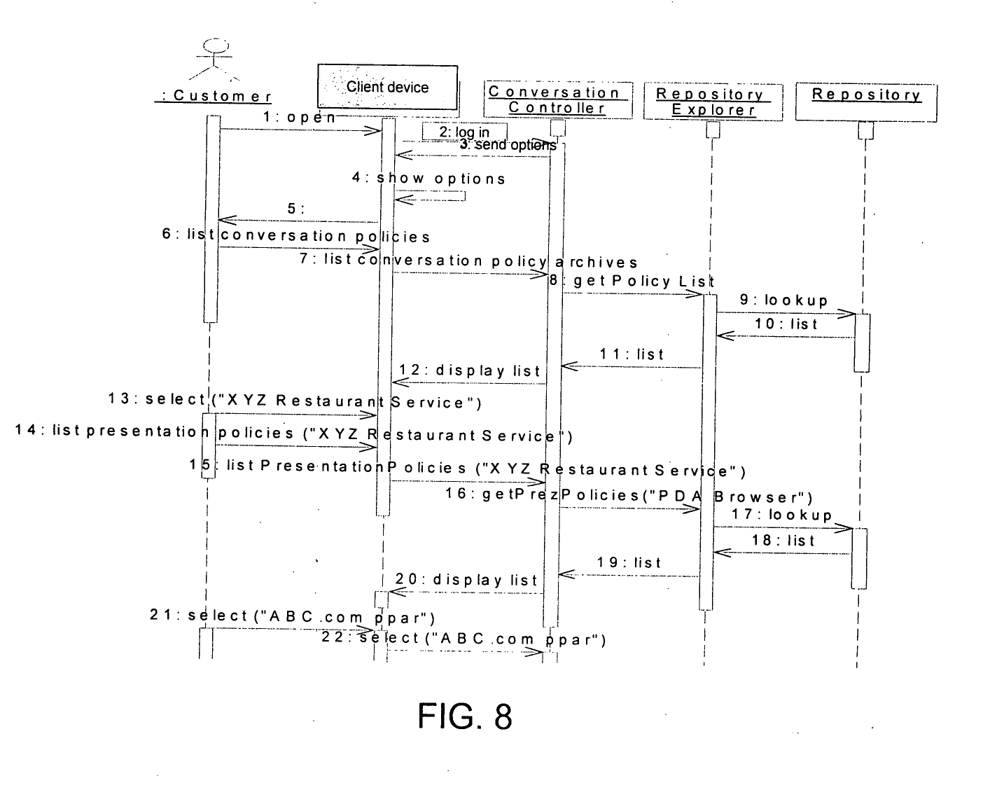

In FIG. 8, the restaurant service is loaded. In steps 1 to 5, the customer opens the user device and logs onto the server. In steps 6 to 13, the customer asks the server to list the policy archives available locally. The customer selects the restaurant service. In steps 14 to 22, the customer asks the server to list the presentation archives available for the restaurant service. The list is retrieved from the repository archive and displayed on the browser. The customer chooses to use the presentation policy from ABC.com.

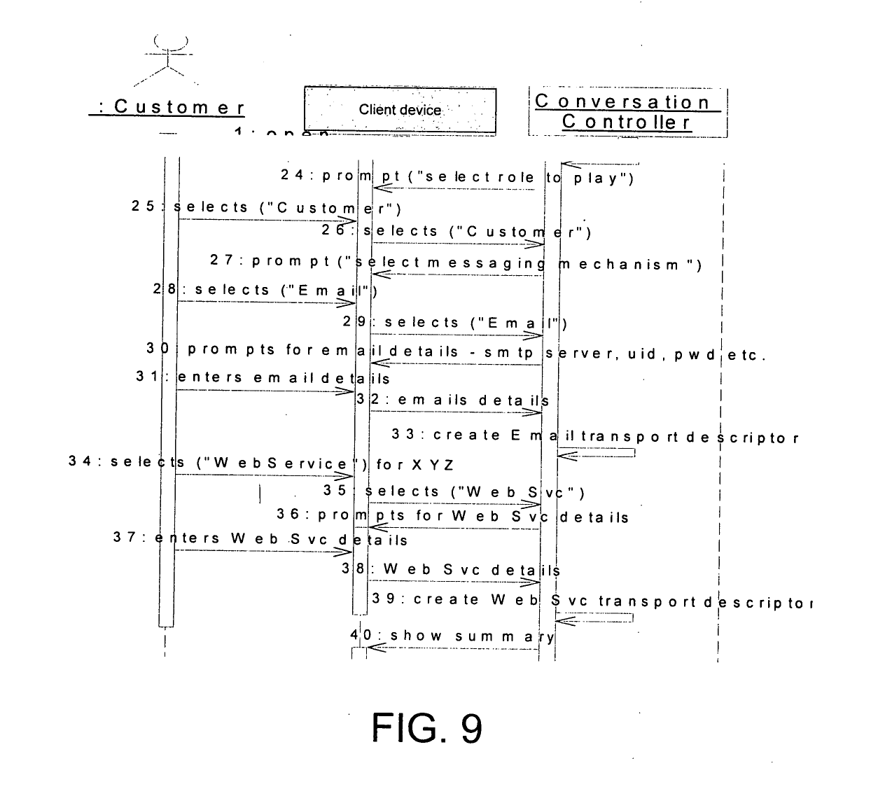

In FIG. 9, the conversation parameters are chosen. In step 24, the server prompts the customer to choose the role he or she wants to play in the conversation. In this case, two choices are displayed: “customer” and “service provider”. In steps 25 and 26, the customer chooses the “customer” role. In step 40, a summary of the choices are displayed which, in this example, are:
Policy Archive: restaurant.par
Presentation Archive: restaurant.ppar
Role Played: Customer

In FIGS. 8 and 9, the conversation policy is selected first, and the partner (i.e., the other party with whom the conversation is to be held) is chosen second, based on a prior choice of the conversation policy. This is only one possible order whereby the conversational parameters may be specified. Alternatively, the user might first select a conversational partner, for example, by specifying the URL of the messaging endpoint provided by that partner, and then specify a CP to use, subject to the constraint that the chosen CP must be supported by the partner.

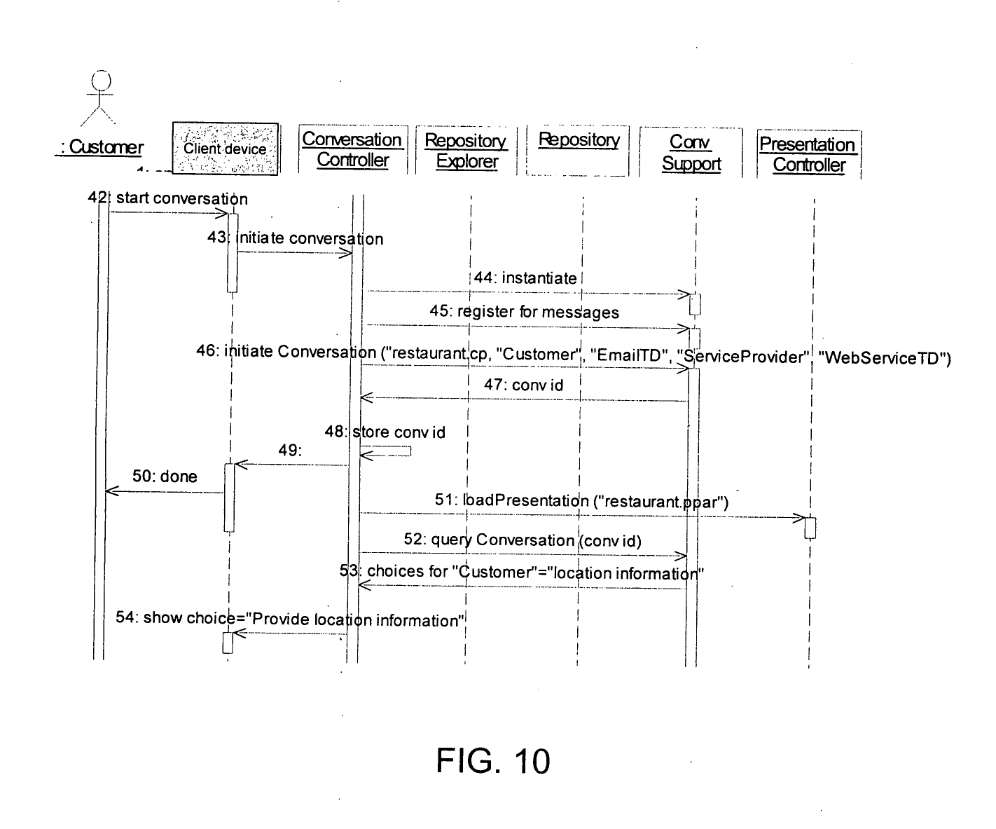

FIG. 10 shows the process of initiating a conversation. In steps 42 and 43, the customer instructs the server via the user device to start the conversation. In step 44, conversation support module 206 light weight implementation is instantiated. In step 45, the conversation controller 205 registers itself with the conversation support module 206 to get receive messages. In step 46, the process “initiate conversation” is invoked on the conversation support module 206, passing in the conversation policy (CP) to load, the role played and the respective transport descriptors. In steps 48 to 50, the conversation identifier returned is stored by the conversation controller 205 and indicates back to the user device the successful conversation initiation. The conversation enters the “Start” state. In step 51, the presentation archive 209, restaurant.ppar, is loaded by the presentation controller. In step 52, the conversation support module 206 is queried to find out who gets to “speak” in the current conversation state and what it is that he or she can say. From the conversation policy, after the conversation is set up, the customer is required to send to the service provider the location information to get restaurant listings. This choice is returned in step 53 as a result of the query. In step 54, the choice is shown to the customer.

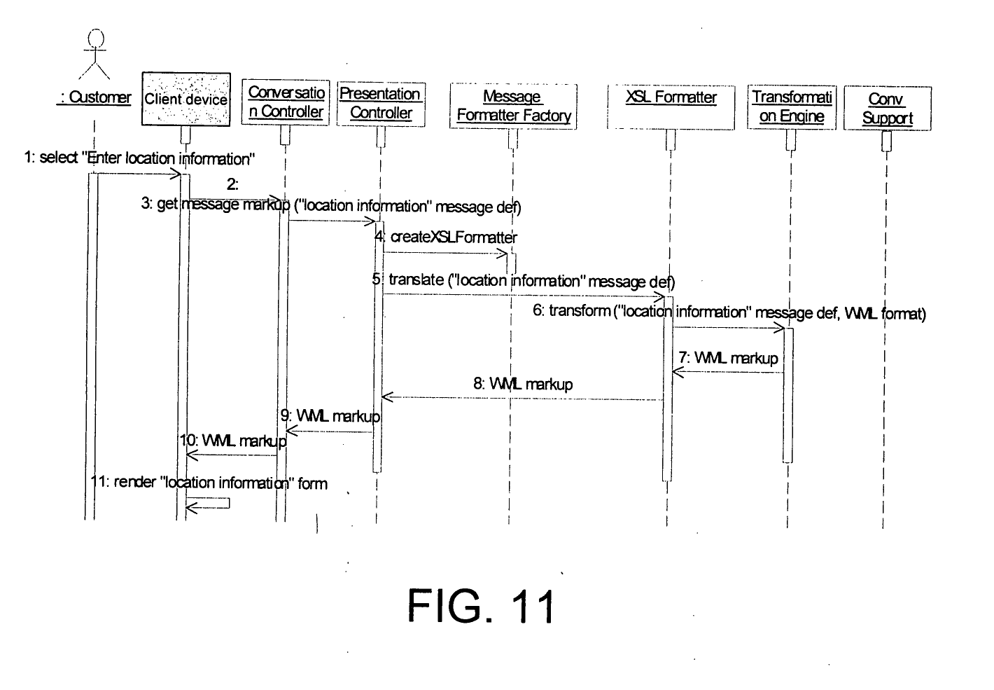

FIG. 11 shows the process of rendering a data input form as part of the process of sending a message. In step 1, the customer selects the choice to enter location information. In steps 2 to 11, the selection in step 1 triggers the server to obtain the message markup to render the appropriate form on the user device for the customer to enter data. This involves creating the appropriate message formatter 43 (in this case, the XSL formatter) and using the mappers from the presentation archive 209 corresponding to the “Location Info” message schema and the type of user device. For example, suppose that the user device is a PDA. The translation engine then produces the Wireless Markup Language (WML) snippet that is sent to the PDA for rendering.

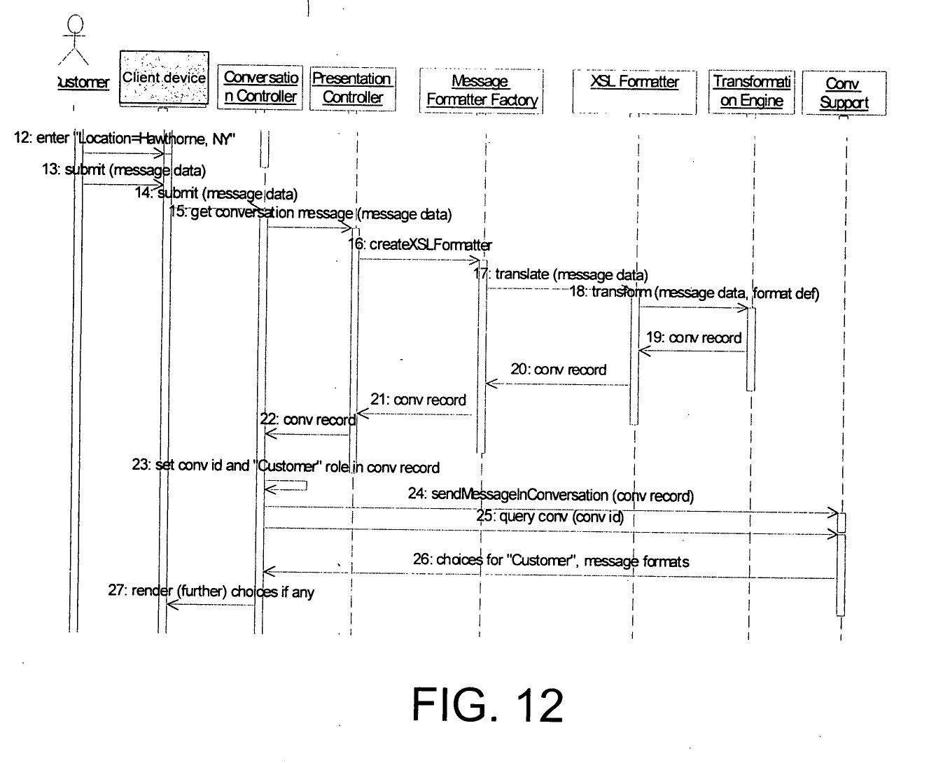

FIG. 12 shows the process of sending the entered data as part of the process of sending a message. In step 12, the customer enters the location data (“Hawthorne, N.Y.” in the example). In steps 13 to 22, the data is submitted to the server and, using the outgoing message mappers, is converted to a format appropriate for sending to the partner. In step 23, the conversation controller 205 sets the role (customer) and conversation ID in the conversation record so that it can be processed and redirected to the appropriate conversation sessions on the service provider. In step 24, the “send Message In Conversation” method is invoked on the conversation support module 206. After the message has been sent, the conversation enters the “Query Made” state, as defined by the conversation policy. In steps 25 to 27, the conversation controller 205 then queries the conversation support module 206 for the next set of “Choices” available for the “customer” role. In this case, there are no choices since the conversation policy indicates that, at this point, the customer needs to await a response from the service provider.

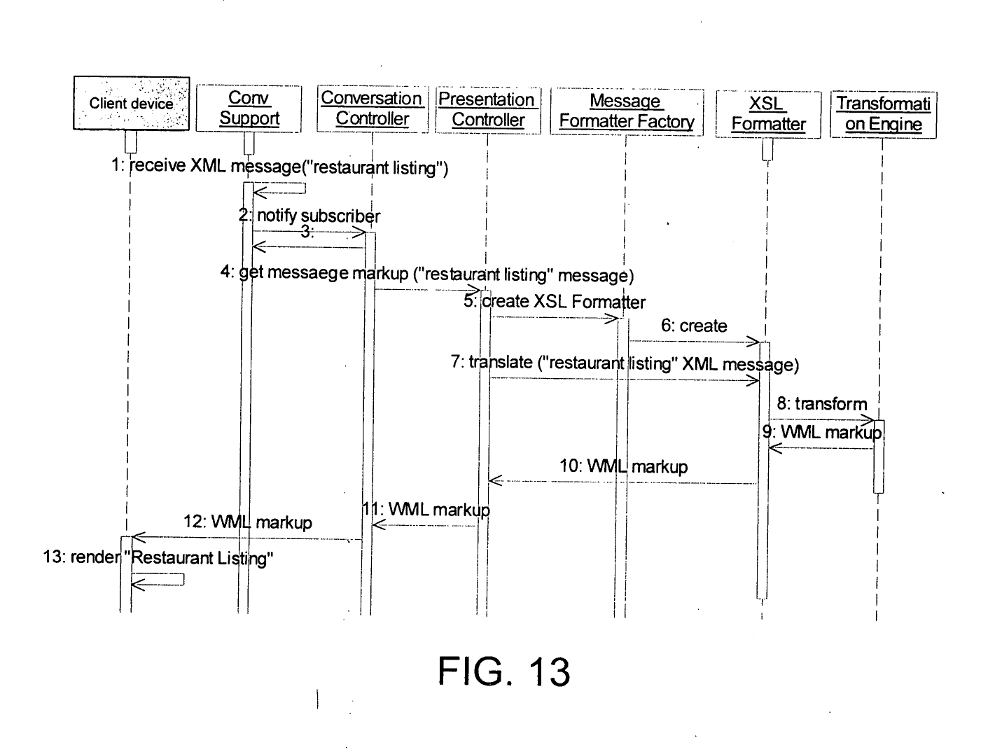

FIG. 13 shows the process of rendering a received message as part of the process of receiving a message. The service provider responds with the list of restaurants available near Hawthorne, N.Y. In step 1, the message is received via the Message Receiver and propagated to the conversation support module 206. In steps 2 and 3, the conversation support module 206 notifies the conversation controller 205 of the incoming message and passes the message to it. The conversation state changes to “Awaiting Selection”, as defined by the installed conversation policy. In steps 4 to 13, as before, the restaurant listing XML message is mapped using the incoming message mappers from the presentation archive 209 into, for example, WML. This WML is then transmitted to the PDA which renders it.

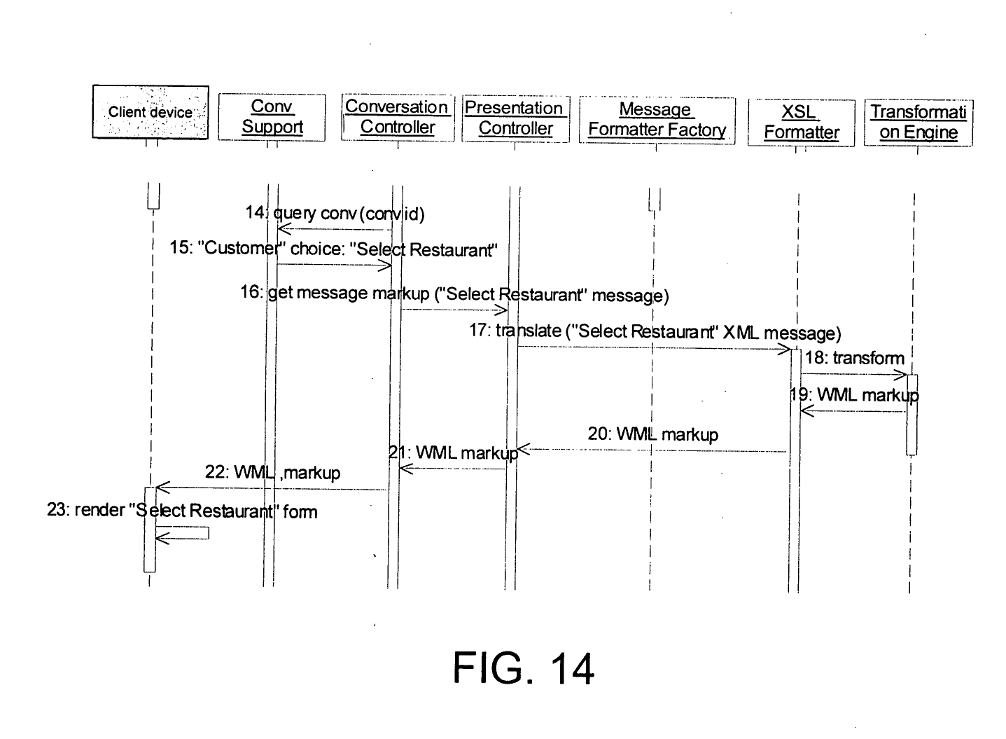

FIG. 14 shows the process of responding to a received message as part of the process of receiving a message. In step 14, the conversation controller 205 queries the conversation support module 206 and finds out the current options available for the “customer”. In step 15, from the installed conversation policy, the customer needs to select a restaurant in the “A waiting Selection” conversation state. In steps 16 to 23, the message mappers from the presentation archive 209 are used to create the appropriate WML form, which is sent to the PDA for rendering. The customer selects the restaurant and transmits the selection back to the server. The server selects the appropriate outgoing message mapper to convert the data receive from the PDA into a message of the correct format as defined by the conversation policy, and sends the formatted message to the other party. The conversation continues until the conversation enters a terminal state (rejection or selection).

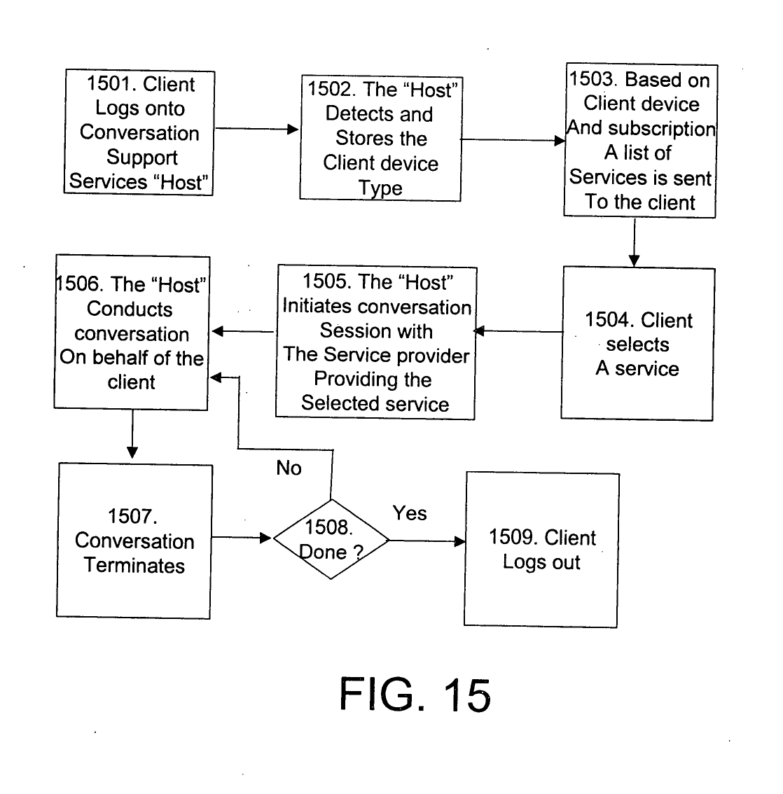

FIG. 15 is a program flow diagram showing the interaction between the conversation support services host 601 and one of the subscribers 610, 611 and 612, shown in FIG. 6. In step 1501, the subscriber (also referred to as “client”) logs onto the host 601. In step 1502, the host then identifies the type of user device in use and stores this information for later use in selecting the presentation policies appropriate to that device. In step 1503, the server accesses client subscription information, such as a list of service types the subscriber is interested in, and based on that information and on the type of user device, the server sends a list of available third-party services with which the user may initiate a conversation. After the client selects a service in step 1504, the host 601 initiates a conversation with that service in step 1505. Thereafter, in step 1506, the conversation proceeds between the host and the selected service, with the host sending information to, and gathering information from, the user device as necessary. In step 1507, the conversation terminates. In step 1508, the host prompts the user as to whether the user wishes to disconnect or to carry on another conversation with the selected service. If the user chooses to continue, step 1506 is executed again. Alternatively, the process could return to step 1503 so that the list of services is presented again for selection. If the user chooses not to continue, the client is logged off in step 1509.

While the invention has been described in terms of a single preferred embodiment, those skilled in the art will recognize that the invention can be practiced with modification within the spirit and scope of the appended claims. For example, it will be understood that the specific example of a restaurant service is but one of many applications which may be implemented with the present invention. Other services might include lodging, for example. And other service providers besides the telephone company may be used. The human-usable interface according to the invention may run on any human interaction device and not just personal computers (PCs) and personal digital assistants (PDAs). For example, cell phones and other such devices supporting the human-usable interface may be used. It is also possible for the client (user) to conduct multiple conversations simultaneously, say while buying merchandise from an online store and making sure that there are available funds with the bank.

1. A system for enabling human users to interact with conversation-enabled applications installed at a remote location, said conversation-enabled applications implementing a conversation policy, the system comprising:
conversation support means communicating with a human-usable interface installed on a user device to support the user's side of a conversation with the conversation-enabled applications;
presentation support means communicating with the human-usable interface installed on the user device to show the user a state of the conversation and options for selection by the user; and
data input means installed on the user device by which the user selects an available option and fills in message content that conforms with the conversation policy in use by the conversation-enabled applications.

2. The system recited in claim 1, wherein in the conversation support means and the presentation support means are installed on the user device.

3. The system recited in claim 1, wherein the conversation support means and the presentation support means are installed on a remote machine which communicates with the user device.

4. The system recited in claim 1, wherein the human-usable interface is a plugin browser.

5. The system recited in claim 1, wherein the data input means prompts the user for decisions and then generates a corresponding screen flow for data input and transforms entered data into a format suitable for delivery to the remote location.

6. The system recited in claim 1, wherein said presentation support means includes an archive of presentation policies accessed to render messages for the user.

7. The system recited in claim 1, wherein the user device is a personal digital assistant.

8. The system recited in claim 1, wherein the user device is a personal computer.

9. The system recited in claim 1, wherein said presentation support is obtained from another system.

10. A method for enabling human users to interact with conversation-enabled applications installed at a remote location, said interaction being by means of a user device having an installed human-usable interface and said conversation-enabled applications implementing a conversation policy, the method comprising the steps of:
loading a selected service device, said service including a policy archive and a presentation archive;
installing a conversation policy supporting the selected service;
accessing the policy archive and communicating with the human-usable interface installed on the user device to support the user's side of a conversation with the conversation-enabled applications;
accessing the presentation archive and communicating with the human-usable interface installed on the user device to show the user a state of the conversation and options for selection by the user; and
prompting user to select an available option and fill in message content that conforms with the conversation policy in use by the conversation-enabled applications.

11. The method recited in claim 10, wherein the policy archive and presentation archive are loaded on the user device and the conversation policy is installed on the user device.

12. The method recited in claim 11, wherein the user device is a personal digital assistant.

13. The method recited in claim 11, wherein the user device is a personal computer.

14. The method recited in claim 10, wherein the policy archive and presentation archive are loaded on a remote machine and the conversation policy is installed on the remote machine, the remote machine communicating with the human-usable interface installed on the user device.

15. The method recited in claim 10, wherein said presentation support is obtained from another system.

16. The method recited in claim 10, wherein the human-usable interface is a plugin browser.
